(19) United States
(12) Patent Application Publication
(10) Pub. No.: US 2025/0036284 A1
(43) Pub. Date: Jan. 30, 2025

(54) TECHNIQUES FOR DATA TRANSFER BETWEEN TIERED MEMORY DEVICES

(71) Applicant: Micron Technology, Inc., Boise, ID (US)

(72) Inventors: David Andrew Roberts, Wellesley, MA (US); Patrick Estep, Rowlett, TX (US)

(21) Appl. No.: 18/774,784

(22) Filed: Jul. 16, 2024

Related U.S. Application Data
(60) Provisional application No. 63/515,311, filed on Jul. 24, 2023.

(51) Int. Cl. G06F 3/06

(52) U.S. Cl. CPC G06F 3/0611; G06F 3/0647; G06F 3/0673

(57) ABSTRACT

Methods, systems, and devices for techniques for data transfer between tiered memory devices are described. A memory system may include a data transfer engine to manage data transfers between different tiers of memory devices within the memory system. The data transfer engine may receive a command which includes a set of source addresses of each of a set of data sets and a set of destination addresses to which the data sets are to be transferred. The data transfer engine may schedule and perform a transfer operation to transfer each of the set of data sets from the respective source address to the respective destination address. The command may further include an indication of an interrupt policy of a set of interrupt policies supported by the data transfer engine. The set of interrupt policies may determine how the data transfer engine may handle interruptions to the data transfer operation.

### CROSS REFERENCE

The present Application for Patent claims priority to U.S. Patent Application No. 63/515,311 by Roberts et al., entitled “TECHNIQUES FOR DATA TRANSFER BETWEEN TIERED MEMORY DEVICES,” filed Jul. 24, 2023, which is assigned to the assignee hereof, and which is expressly incorporated by reference in its entirety herein.

### TECHNICAL FIELD

The following relates to one or more systems for memory, including techniques for data transfer between tiered memory devices.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells in a non-volatile configuration may maintain stored logic states for extended periods of time even in the absence of an external power source. Memory cells in a volatile configuration may lose stored states when disconnected from an external power source.

### BRIEF DESCRIPTION OF THE DRAWINGS

FIG. 1 shows an example of a system that supports techniques for data transfer between tiered memory devices in accordance with examples as disclosed herein.

FIG. 2 shows an example of a system that supports techniques for data transfer between tiered memory devices in accordance with examples as disclosed herein.

FIG. 3 shows an example of a system that supports techniques for data transfer between tiered memory devices in accordance with examples as disclosed herein.

FIG. 4 shows an example of a process flow that supports techniques for data transfer between tiered memory devices in accordance with examples as disclosed herein.

FIG. 5 shows an example of a process flow that supports techniques for data transfer between tiered memory devices in accordance with examples as disclosed herein.

FIG. 6 shows a block diagram of a data transfer engine that supports techniques for data transfer between tiered memory devices in accordance with examples as disclosed herein.

FIGS. 7 and 8 show flowcharts illustrating methods that support techniques for data transfer between tiered memory devices in accordance with examples as disclosed herein.

### DETAILED DESCRIPTION

Some memory systems may contain one or more memory devices having diverse performance characteristics, such as a first memory device having a first access speed (e.g., a first tier of memory device), a second memory device having a second access speed greater than the first access speed (e.g., a second tier of memory device), and so on. (e.g., the memory system may be a tiered memory system). In some cases, a memory system may transfer data (e.g., migrate data) between different tiers, for example as part of background operations of the memory system (e.g., read and write operations, wear leveling procedures) or to improve the performance of the memory system (e.g., relocate highly used data to a higher performance memory device). To support such data transfer, a host device may be coupled with the memory system and may issue commands for data transfers to a component of the memory system, such as a data mover, to execute the issued commands. However, managing the data transfer may be resource intensive, and thus the host device may experience decreased performance (e.g., high latency) due to assisting in the data transfers of the memory system.

As described herein, a memory system may include a data transfer engine coupled with a host device to manage data transfers between different tiers of memory devices within the memory system. The data transfer engine may receive, from the host device, a command which includes a set of source addresses corresponding to current physical addresses (e.g., in a first tier) of each of a set of data sets and a set of destination addresses corresponding to physical addresses (e.g., in a second tier) of the memory system to which the data sets are to be transferred. In response to the command, the data transfer engine may schedule and perform a transfer operation to transfer each of the set of data sets from the respective source address to the respective destination address. In some examples, the command may further include an indication of an interrupt policy of a set of interrupt policies supported by the data transfer engine. The set of interrupt policies may determine how the data transfer engine may handle interruptions to the data transfer operation (e.g., write commands from the host device containing a write address associated with a transpiring data transfer operation). After the data transfer engine has completed a data transfer operation, the data transfer engine may transmit an indication that the data transfer operation has been completed to the host device.

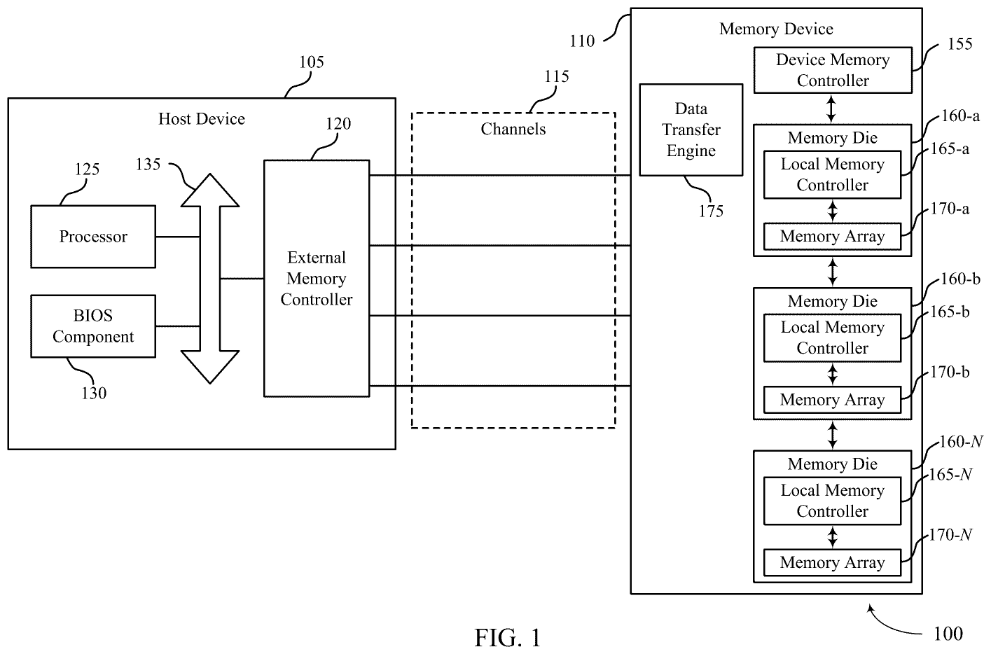

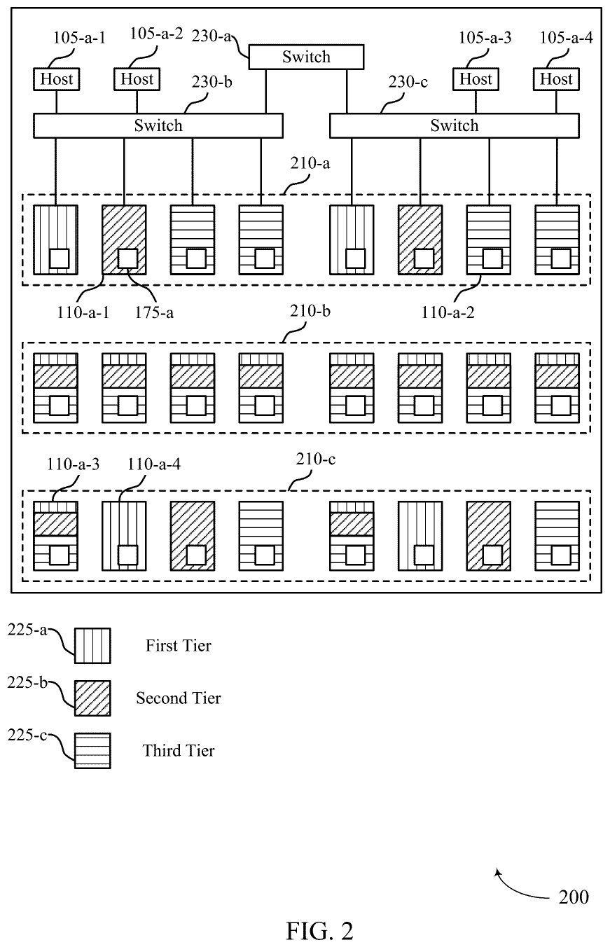

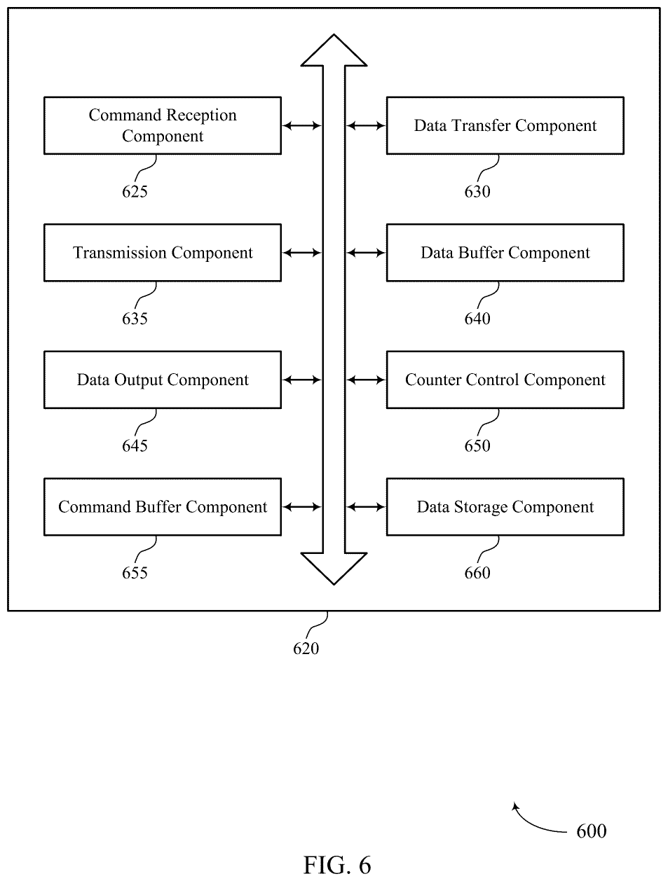

Features of the disclosure are initially described in the context of systems and dies as described with reference to FIG. 1. Features of the disclosure are described in the context of systems and process flows as described with reference to FIGS. 2 through 5. These and other features of the disclosure are further illustrated by and described with reference to an apparatus diagram and flowcharts that relate to techniques for data transfer between tiered memory devices as described with reference to FIGS. 6 through 8.

FIG. 1 shows an example of a system 100 that supports techniques for data transfer between tiered memory devices in accordance with examples as disclosed herein. The system 100 may include a host device 105, a memory device 110, and a plurality of channels 115 coupling the host device 105 with the memory device 110. The system 100 may include one or more memory devices 110, but aspects of the one or more memory devices 110 may be described in the context of a single memory device (e.g., memory device 110).

The system 100 may include portions of an electronic device, such as a computing device, a mobile computing device, a wireless device, a graphics processing device, a vehicle, or other systems. For example, the system 100 may illustrate aspects of a computer, a laptop computer, a tablet computer, a smartphone, a cellular phone, a wearable device, an internet-connected device, a vehicle controller, or the like. The memory device 110 may be a component of the system 100 that is operable to store data for one or more other components of the system 100.

Portions of the system 100 may be examples of the host device 105. The host device 105 may be an example of a processor (e.g., circuitry, processing circuitry, a processing component) within a device that uses memory to execute processes, such as within a computing device, a mobile computing device, a wireless device, a graphics processing device, a computer, a laptop computer, a tablet computer, a smartphone, a cellular phone, a wearable device, an internet-connected device, a vehicle controller, a system on a chip (SoC), or some other stationary or portable electronic device, among other examples. In some examples, the host device 105 may refer to the hardware, firmware, software, or any combination thereof that implements the functions of an external memory controller 120. In some examples, the external memory controller 120 may be referred to as a host (e.g., host device 105).

A memory device 110 may be an independent device or a component that is operable to provide physical memory addresses/space that may be used or referenced by the system 100. In some examples, a memory device 110 may be configurable to work with one or more different types of host devices. Signaling between the host device 105 and the memory device 110 may be operable to support one or more of: modulation schemes to modulate the signals, various pin configurations for communicating the signals, various form factors for physical packaging of the host device 105 and the memory device 110, clock signaling and synchronization between the host device 105 and the memory device 110, timing conventions, or other functions.

The memory device 110 may be operable to store data for the components of the host device 105. In some examples, the memory device 110 (e.g., operating as a secondary-type device to the host device 105, operating as a dependent-type device to the host device 105) may respond to and execute commands provided by the host device 105 through the external memory controller 120. Such commands may include one or more of a write command for a write operation, a read command for a read operation, a refresh command for a refresh operation, or other commands.

The host device 105 may include one or more of an external memory controller 120, a processor 125, a basic input/output system (BIOS) component 130, or other components such as one or more peripheral components or one or more input/output controllers. The components of the host device 105 may be coupled with one another using a bus 135.

The processor 125 may be operable to provide functionality (e.g., control functionality) for the system 100 or the host device 105. The processor 125 may be a general-purpose processor, a digital signal processor (DSP), an application-specific integrated circuit (ASIC), a field-programmable gate array (FPGA) or other programmable logic device, discrete gate or transistor logic, discrete hardware components, or any combination of these components. In such examples, the processor 125 may be an example of a central processing unit (CPU), a graphics processing unit (GPU), a general purpose GPU (GPGPU), or an SoC, among other examples. In some examples, the external memory controller 120 may be implemented by or be a part of the processor 125.

The BIOS component 130 may be a software component that includes a BIOS operated as firmware, which may initialize and run various hardware components of the system 100 or the host device 105. The BIOS component 130 may also manage data flow between the processor 125 and the various components of the system 100 or the host device 105. The BIOS component 130 may include instructions (e.g., a program, software) stored in one or more of read-only memory (ROM), flash memory, or other non-volatile memory.

The memory device 110 may include a device memory controller 155 and one or more memory dies 160 (e.g., memory chips) to support a capacity (e.g., a desired capacity, a specified capacity) for data storage. Each memory die 160 (e.g., memory die 160-a, memory die 160-b, memory die 160-N) may include a local memory controller 165 (e.g., local memory controller 165-a, local memory controller 165-b, local memory controller 165-N) and a memory array 170 (e.g., memory array 170-a, memory array 170-b, memory array 170-N). A memory array 170 may be a collection (e.g., one or more grids, one or more banks, one or more tiles, one or more sections) of memory cells, with each memory cell being operable to store one or more bits of data. A memory device 110 including two or more memory dies 160 may be referred to as a multi-die memory or a multi-die package or a multi-chip memory or a multi-chip package.

The device memory controller 155 may include components (e.g., circuitry, logic) operable to control operation of the memory device 110. The device memory controller 155 may include hardware, firmware, or instructions that enable the memory device 110 to perform various operations and may be operable to receive, transmit, or execute commands, data, or control information related to the components of the memory device 110. The device memory controller 155 may be operable to communicate with one or more of the external memory controller 120, the one or more memory dies 160, or the processor 125. In some examples, the device memory controller 155 may control operation of the memory device 110 described herein in conjunction with the local memory controller 165 of the memory die 160.

In some examples, the memory device 110 may communicate information (e.g., data, commands, or both) with the host device 105. For example, the memory device 110 may receive a write command indicating that the memory device 110 is to store data received from the host device 105, or receive a read command indicating that the memory device 110 is to provide data stored in a memory die 160 to the host device 105, among other types of information communication.

A local memory controller 165 (e.g., local to a memory die 160) may include components (e.g., circuitry, logic) operable to control operation of the memory die 160. In some examples, a local memory controller 165 may be operable to communicate (e.g., receive or transmit data or commands or both) with the device memory controller 155. In some examples, a memory device 110 may not include a device memory controller 155, and a local memory controller 165 or the external memory controller 120 may perform various functions described herein. As such, a local memory controller 165 may be operable to communicate with the device memory controller 155, with other local memory controllers 165, or directly with the external memory controller 120, or the processor 125, or any combination thereof. Examples of components that may be included in the device memory controller 155 or the local memory controllers 165 or both may include receivers for receiving signals (e.g., from the external memory controller 120), transmitters for transmitting signals (e.g., to the external memory controller 120), decoders for decoding or demodulating received signals, encoders for encoding or modulating signals to be transmitted, or various other components operable for supporting described operations of the device memory controller 155 or local memory controller 165 or both.

The external memory controller 120 may be operable to enable communication of information (e.g., data, commands, or both) between components of the system 100 (e.g., between components of the host device 105, such as the processor 125, and the memory device 110). The external memory controller 120 may process (e.g., convert, translate) communications exchanged between the components of the host device 105 and the memory device 110. In some examples, the external memory controller 120, or other component of the system 100 or the host device 105, or its functions described herein, may be implemented by the processor 125. For example, the external memory controller 120 may be hardware, firmware, or software, or some combination thereof implemented by the processor 125 or other component of the system 100 or the host device 105. Although the external memory controller 120 is depicted as being external to the memory device 110, in some examples, the external memory controller 120, or its functions described herein, may be implemented by one or more components of a memory device 110 (e.g., a device memory controller 155, a local memory controller 165) or vice versa.

The components of the host device 105 may exchange information with the memory device 110 using one or more channels 115. The channels 115 may be operable to support communications between the external memory controller 120 and the memory device 110. Each channel 115 may be an example of a transmission medium that carries information between the host device 105 and the memory device 110. Each channel 115 may include one or more signal paths (e.g., a transmission medium, a conductor) between terminals associated with the components of the system 100. A signal path may be an example of a conductive path operable to carry a signal. For example, a channel 115 may be associated with a first terminal (e.g., including one or more pins, including one or more pads) at the host device 105 and a second terminal at the memory device 110. A terminal may be an example of a conductive input or output point of a device of the system 100, and a terminal may be operable to act as part of a channel.

Channels 115 (and associated signal paths and terminals) may be dedicated to communicating one or more types of information. For example, the channels 115 may include one or more command and address channels, one or more clock signal channels, one or more data channels, one or more other channels, or any combination thereof. Additionally, or alternatively, the channels 115 may be configured to operate according to one or more interface protocols, such as an advanced extensible interface (AXI) protocol, a compute express link (CXL) protocol, a peripheral component interconnect express (PCIe) protocol, a universal flash storage (UFS) protocol, an M-PHY protocol, or any combination thereof. In some examples, signaling may be communicated over the channels 115 using single data rate (SDR) signaling, double data rate (DDR) signaling, or graphics DDR (GDDR) signaling. In SDR signaling, one modulation symbol (e.g., signal level) of a signal may be registered for each clock cycle (e.g., on a rising or falling edge of a clock signal). In DDR signaling, two modulation symbols (e.g., signal levels) of a signal may be registered for each clock cycle (e.g., on both a rising edge and a falling edge of a clock signal).

In some cases, a memory system may include a data transfer engine 175 coupled with a host device 105 to manage data transfers between different tiers of memory devices 110 within the memory system. The data transfer engine 175 may receive, from the host device 105, a command which includes a set of source addresses corresponding to current physical addresses (e.g., in a first tier) of each of a set of data sets and a set of destination addresses corresponding to physical addresses (e.g., in a second tier) of the memory system to which the data sets are to be transferred. In response to the command, the data transfer engine 175 may schedule and perform a transfer operation to transfer each of the set of data sets from the respective source address to the respective destination address. In some examples, the command may further include an indication of an interrupt policy of a set of interrupt policies supported by the data transfer engine 175. The set of interrupt policies may determine how the data transfer engine 175 may handle interruptions to the data transfer operation (e.g., write commands from the host device 105 containing a write address associated with a transpiring data transfer operation). After the data transfer engine 175 has completed a data transfer operation, the data transfer engine 175 may transmit an indication that the data transfer operation has been completed to the host device 105.

In addition to applicability in memory systems as described herein, techniques for data transfer between tiered memory devices may be generally implemented to support increased connectivity of electronic systems. As the use of systems relying on interconnected electronic devices increases, the connectivity of these electronic devices becomes an increasingly relevant factor for the operations of the system. For example, delays associated with signals communicated between devices may become increasingly relevant as critical systems come to rely more on connectivity, as a system uses larger quantities of interconnected devices, or if the quantity and the complexity of signals communicated between devices increases. Implementing the techniques described herein may support techniques for increased connectivity in electronic systems by increasing the speed and reliability of data transfer operations between different tiers of memory, among other benefits.

FIG. 2 shows an example of a system 200 that supports techniques for data transfer between tiered memory devices in accordance with examples as disclosed herein. The system 200 may include aspects of the system 100. For example, the system 200 may include one or more host devices 105-a (e.g., host device 105-a-1, host device 105-a-2, host device 105-a-3, and host device 105-a-4) coupled with one or more memory systems 210 (e.g., a memory system 210-a, a memory system a 210-b, a memory system 210-c, or a combination thereof). In some cases, a host device 105-a may couple with a memory system 210 or one or more memory devices 110-a of a memory system 210 using a switch 230. A memory system 210 may include a set of memory devices 110-a (e.g., memory device 110-a-1, memory device 110-a-2, memory device 110-a-3, and memory device 110-a-4), each of which may include a respective data transfer engine 175-a to support a data transfer operation between different memory devices 110-a, different tiers 225 of memory, or both. As described herein, a data transfer engine 175 may be a controller (e.g., processor), that may include components (e.g., circuitry, logic) operable to control operations of a memory device 110 related to data transfer. A data transfer engine 175 may include hardware, firmware, or instructions that enable the memory device 110 to perform various operations, and may be part of a memory system 210, a memory device 110, a memory subsystem, a host device 105, a device memory controller, a local memory controller, an external memory controller, or a combination thereof. Although FIG. 2 illustrates certain quantities of components, one skilled in the art may recognize that such quantities are merely illustrative, and that any quantity of components may be present in the system 200.

A memory system 210 may be an example of a multi-tiered memory system, which may include multiple memory devices 110-a having different tiers 225 (e.g., diverse performance characteristics, such as latencies, bandwidths, longevities, or combinations thereof), such as a tier 225-a, a tier 225-b, a tier 225-c, or a combination thereof. In some cases, a memory device 110-a of a tier 225 may include memory technologies (e.g., NAND, DRAM, SRAM commensurate with performance characteristics of the tier 225. In some examples, a memory device 110-a may be associated with a single tier 225. Alternatively, a memory device 110-a may include or may support multiple tiers 225. The memory systems 210 included in the system 200 may illustrate variations in the type of tiered memory devices 110-a included in the respective memory system. For example, the memory system 210-a may include memory devices 110-a which are each associated with a single tier 225, the memory system 210-b may include memory devices 110-a which are each associated with multiple tiers 225, and the memory system 210-c may include memory devices 110-a which may each be associated with a single tier 225 or with multiple tiers 225.

One or more of the host devices 105-a may be coupled to a memory system 210 using one or more of the switches 230. In some cases, the switches 230 may enable host devices 105-a to communicate directly with multiple memory devices 110-a within a memory system 210. Additionally, a host device 105-a coupled with a memory system 210 may send commands to the data transfer engines 175-a of memory devices 110-a of the memory system 210. For example, a memory device 110-a of a memory system 210 may receive a command from the host device 105-a-1 at an associated the data transfer engine 175-a, and may, concurrently or subsequently, receive a command from the host device 105-a-1 at the data transfer engine 175-a.

A memory system 210 may transfer data sets (e.g., data stored in a page of memory cells, data stored in a block of memory cells) between different tiers 225, for example to move relatively more frequently accessed (e.g., hot) data sets to a higher performance tier 225, move relatively less frequently accessed (e.g., cold) data sets to a lower performance tier 225, or both. In some cases, a host device 105-a may manage such data transfer operations. For example, the host device 105-a may identify hot data sets, cold data sets, or both and may, for each identified data set, issue a command to a memory device 110-a which stores the identified data set to transfer the data set from a source address within a current tier 225 to a destination address within an appropriate tier 225 (e.g., a higher tier 225 for hot data sets, a lower tier 225 for cold data sets).

In some examples, an operating system of the host device 105-a may allocate one or more new pages for a data set (e.g., at the destination address) and copy the data set from the source address to the allocated pages at the destination address. The operating system may further create or modify a mapping (e.g., an L2P table) to include a relation between one or more logical addresses of the data set and the destination address and remove a relation between one or more logical addresses of the data set and the source address. In some cases, the operating system may erase or otherwise free the pages at the source address and invalidate one or more corresponding entries in a translation lookaside buffer (TLB). Performing such management by the host device 105-a may accordingly reduce performance (e.g., increase latency) of the system 200.

Alternatively, each memory device 110-a may include a respective data transfer engine 175-a to manage aspects of data transfer operations. For example, the host device 105-a may transmit a command (e.g., a batch command) to a data transfer engine 175-a which may instruct the data transfer engine to perform one or more data transfer operations between memory devices 110-a of the memory system. The command may include one or more source addresses corresponding to one or more data sets, one or more destination addresses for the one or more data sets, an indication of an interrupt policy of a set of interrupt policies, or a combination thereof. The memory device 110-a associated with the data transfer engine 175-a may include a source address of the set of source addresses, a destination address of the set of destination addresses, or both. Alternatively, the memory device 110-a may be neither a source address of the set of source addresses nor a destination address of the set of destination addresses. That is, the command may be received by a data transfer engine 175-a of any memory device 110-a of the memory system, and may include source addresses and destination addresses for any location within any memory device 110-a of the memory system 210. In response to the command, the data transfer engine 175-a may transfer each data set from the associated source address to the associated destination address. In some examples, after completing the data transfer operation, the data transfer engine 175-a may transmit an indication to the host device 105-a that the data transfer operation has been completed.

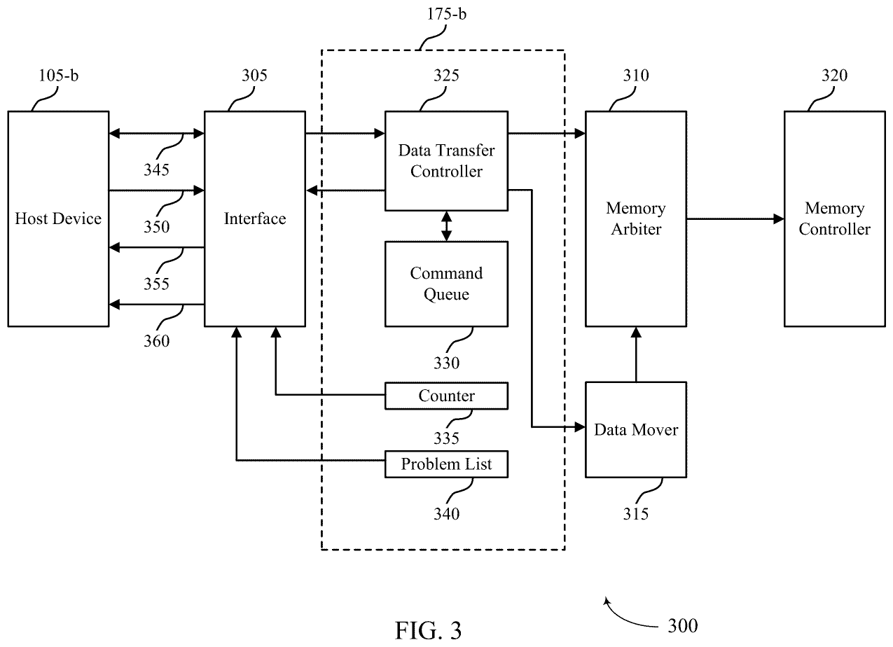

The command sent from the host device 105-a to the data transfer engine 175-a may be an example of a variable-length batch command. In some cases, a batch command may include a barrier flag, one or more fence flags, an indication of a type of the batch command, a variable quantity of data set fields, or a combination thereof, as described in greater detail with reference to FIG. 3. Each data set field may correspond to a single data set, and may include an identifier for the batch command, a source address of the data set, a destination address for the data set, a size of the data set, an indication of an interrupt policy for transferring the data set, a priority associated with transferring the data set, or any combination thereof. Such a batch command may allow the data transfer engine 175-a to manage aspects of a data transfer operation, which may reduce resources consumed by the host device 105-a (e.g., resources associated with host address translation), which may accordingly reduce latency of the system 200.

After completing a data transfer operation associated with a data set field of a command, or completing a batch command, the data transfer engine 175-a may transmit a batch acknowledgement to the entity which sent the batch command (e.g., a host device 105-a, a memory device 110-a). For example, the data transfer engine 175-a may receive a batch command which includes multiple data set fields from the host device 105-a, and begin executing the batch command. After the data transfer engine 175-a completes a data set field of the batch command, the data transfer engine 175-a may transmit a batch acknowledgement to the host device 105-a indicating the completion of the data set field. Additionally, or alternatively, the data transfer engine 175-a may complete the entire batch command and transmit a batch acknowledgement to the host device 105-a indicating the completion of the batch command.

In some instances, the data transfer engines 175-a may perform a data transfer operation in which a source address for a first data set corresponds to a destination address for a second data set (e.g., a shuffle, an N-way shuffle). To perform such an operation, the data transfer engine 175-a may initially write one or more data sets associated with the operation to a buffer of the data transfer engine 175-a. For example, the data transfer engine 175-a may read each data set indicated in the batch command from the corresponding source addresses and write the data sets to the buffer associated with the data transfer engine 175-a. Subsequently, the data transfer engine 175-a may output the data sets from the buffer to the respective destination addresses. In some cases, the reading, storing, or outputting of one data set may occur concurrently (e.g., at least partially overlap in time) with reading, storing, or outputting of another set of data (e.g., the data transfer engine 175-a may transfer the data sets concurrently).

In some cases, the memory system 210 may execute multiple batch commands concurrently. For example, a first data transfer engine 175-a of a first memory device 110-a may perform a first data transfer operation associated with a first batch command, and a second data transfer engine 175-a of a second memory device 110-a may perform a second data transfer operation associated with a second batch command. In such cases, performing the first data transfer operation and performing the second data transfer operation may at least partially overlap in time. In some examples, communication between the first data transfer engine 175-a and the second data transfer engine 175-a may prevent errors from occurring while performing the data transfer operations (e.g., if accessing a same memory location).

An interrupt policy included in a data set field of a batch command may include information associated with the handling of interruptions from the host devices 105-a. Interruptions may include receiving a write command from a host device 105-a during the execution of a batch command. In the case of such an interruption, the interrupt policy indicated by the batch command may direct the data transfer engine 175-a on how to handle the received write command. In one example, the interrupt policy may direct the data transfer engine 175-a to store the received write command to a buffer and write the data associated with the received write command from the buffer after the completion of the batch command. In some cases, the data transfer engine 175-a may determine that the buffer used to store the received write commands is full. In such cases, the data transfer engine 175-a may abort the received write command, and may transmit an indication of the aborted write command to the host device 105-a. In another example, the interrupt policy may direct the data transfer engine 175-a to abort the received write command and transmit a negative acknowledgement (NACK) of the write command to the host device 105-a. In yet another example, the interrupt policy may direct the data transfer engine 175-a to abort a portion of the batch command (e.g., at least one data set field), or abort each data set field included in the batch command upon receiving the write command. In such an example, the data transfer engine may transmit an indication of the identifier of the batch command to the host device 105-a.

Interrupt policies may be applied to entire batch commands, or to individual data set fields of a batch command. As discussed above, each data set field of a batch command may contain an interrupt policy for the respective data set field. Additionally, the batch command may contain an interrupt policy to be applied to the entirety of the batch command. In some cases, differing interrupt policies may provide improved performance based on aspects of the batch command (e.g., the location of the source and destination addresses, the number of blocks in a batch command, the tiers of the memory devices associated with the batch command).

FIG. 3 shows an example of a system 300 that supports techniques for data transfer between tiered memory devices in accordance with examples as disclosed herein. The system 300 may implement or include aspects of the system 100, the system 200, or both. For example, the system 300 may include a host device 105-b in communication with a data transfer engine 175-b. In some examples, the data transfer engine 175-b may be coupled with a memory controller 320 of a memory device (e.g., a memory device 110). The system 300 may include an interface 305, which may support communication between the host device 105-b and the data transfer engine 175-b. Additionally, the system 300 may include a data mover 315 and memory arbiter 310, which may support the data transfer engine in data transfer operations. The data transfer engine 175-b may contain a data transfer controller 325, a command queue 330, a counter 335, and a problem list 340.

The host device 105-b may communicate commands, data, or both with the data transfer engine 175-b via the interface 305. For example, the host device 105-b may generate and transmit access commands 345 (e.g., read commands, write commands) and associated data to the interface 305. In some cases, the access commands 345 and associated data may pass through the data transfer engine 175-b (e.g., via the data transfer controller 325) to the memory arbiter 310 and to the memory controller 320. Additionally, the host device 105-a may transmit one or more batch commands 350, to the interface 305, and the interface 305 may transmit one or more indications 355 of completed or aborted batch commands to the host device 105-b.

The data transfer controller 325 may assist in performing batch commands in a memory device coupled to the system 300. For example, the data transfer engine 175-b may receive batch commands 350 from the interface 305, process the received batch commands 350, schedule and perform data transfers (e.g., using the data mover 315) according to the received batch commands 350, and transmit batch command indications 355 (e.g., completion, abortion, write abortion) to the host device 105-b using the interface 305. The batch commands 350 received by the data transfer controller 325 may vary in size (e.g., vary in quantity of data set fields). The batch command indications 355 may be transmitted to the host device 105-b using a queue accessible to the host device 105-b (e.g., an in-memory queue), an interrupt transmitted to the host device 105-b, or both. In some examples, the batch command indications 355 may include an identifier of the associated batch command 350. Additionally, the host device 105-b may update a memory map (e.g., virtual to physical page map, L2P table) in response to receiving batch command indications.

The data transfer controller 325 may implement interrupt policies associated with received batch commands 350. For example, the memory controller 320 may be operable to detect (e.g., snoop) access commands 345 transmitted from the interface 305 to the memory arbiter 310. In some cases, a write command with a write address associated with a current (e.g., on-going) data transfer operation may be transmitted from the host device 105-b. In such a case, one or more interrupt policies included in the batch command may indicate to the data transfer controller 325 a method to process the received write command, the current data transfer operation, or both.

For example, as part of a first interrupt policy, the data transfer controller 325 may store the received write command to a buffer. After the data transfer engine 175-b has completed the data transfer operation, the data transfer controller 325 may output the write command to the memory controller 320, and the memory controller 320 may process the write command. In such an example, the data transfer controller 325 may complete all buffered writes before the host device 105-b may update an associated memory map. In some cases, the data transfer controller 325 may determine that the buffer is full. In such cases, the data transfer controller 325 may abort the received write command, and the data transfer controller 325 may transmit an indication of the aborted write command to the host device 105-b.

As part of a second interrupt policy, the data transfer controller 325 may abort the received write command and transmit a negative acknowledgement (NACK) of the write command to the host device 105-b. As part of a third interrupt policy, the data transfer controller 325 may abort one or more portions of the data transfer operation (e.g., may abort transferring one or more data sets indicated in one or more data set fields), or may abort each transferring data sets of each data set field of a batch command 350. In such cases, the data transfer controller 325 may transmit the identifier of the batch command 350 to the host device 105-b.

The data transfer controller 325 may store received batch commands in the command queue 330 (e.g., a local command queue), or the host device 105-b may transmit an address of a queue (e.g., a pointer to an in-memory queue) which stores one or more batch commands 345. In some cases, queues stored in a separate memory device may be copied to the command queue 330 for processing (e.g., assigning states, updating queues). As batch commands are completed or aborted, the data transfer controller 325 may notify the host device 105-b by transmitting an indication 355 of the completion or abortion to the interface 305.

In some examples, the command queue 330 may store a state associated with each batch command 350. Such states may include a valid state (e.g., indicating that the batch command 350 does not include errors, and may be executed), an issued state (e.g., indicating that a data transfer operation associated with the batch command is currently underway), and a completed state (e.g., indicating that the batch command 350 has been completed). States may correspond to an entire batch command 350, or to one or more portions (e.g., one or more data set fields) of a batch command 350.

The counter 335 may track instances of data transfer events associated with a batch command 350, and may transmit (e.g., expose) a value of the counter 335 to the host device 105-b. For example, the counter 335 may track a quantity of a total incoming and outgoing data transfers (e.g., data transfer bandwidth), a quantity of data sets (e.g., blocks, pages) that have been transferred, a quantity of data transfers (e.g., batch commands 350, data set fields of a batch command 350) aborted and retried due to a write interrupt, or a combination thereof. The interface 305 may read the value of the counter 335 and transmit the value to the host device 105-b. The host device 105-b may use the value to inform future behaviors and support mitigate performance problems (e.g., high latency).

The problem list 340 may support troubleshooting of a memory device or a memory system coupled to the system 300. For example, the problem list 340 may track physical addresses, batch identifiers, or both of data sets associated with a data transfer that experiences issues. In some cases, the problem list 340 may track data sets which experience repeated write interrupts (e.g., a quantity of write interrupts which exceed a threshold) during a data transfer operation, or that experience delays (e.g., with lengths that may exceed a delay threshold) in a data transfer operation. Such delays may be due to high bandwidth utilization (e.g., back-pressure) on a memory device coupled with the system 300, or other reasons. The data transfer engine 175-b may store the problem list 340 in a buffer in a memory device coupled with the system 300, or in a main memory region accessible to the host device 105-b and the memory device coupled to the system 300. In response to problem list entries associated with a data set, the host device 105-b may store the data set to a specific memory, reduce the migration frequency of the data set, schedule migration commands associated with the data set at different times to avoid interruptions, insert thread waiting (e.g., locks) or an active barrier flag in the batch commands associated with the data sets, or a combination thereof.

In some examples, the data transfer engine 175-b may transmit metadata 360 associated with the counter 335, the problem list 340, or both to the host device 105-b. The metadata 360 may include telemetry (e.g., information from the counter 335 and the problem list 340) associated with one or more memory devices coupled to the system 300 may be transmitted from the interface 305 to the host device 105-b.

The data mover 315 may assist in performing data transfers according to the batch commands 350 received and read by the data transfer controller 325. The data mover 315 may include one or more data copy engines operable to perform concurrent data transfers. In response to commands from the data transfer controller 325, a copy engine of the data mover 315 may copy data sets within or across memory devices coupled with the system 300 and within or across local memory of the host device 105-b. The data mover 315, the data transfer controller 325, or both may enforce active barrier flags between individual data transfer commands (e.g., data set fields of a batch command). For example, the data transfer controller 325 may enforce an active barrier flag by not transmitting commands to the data mover 315 until the data mover 315 has executed previously received commands.

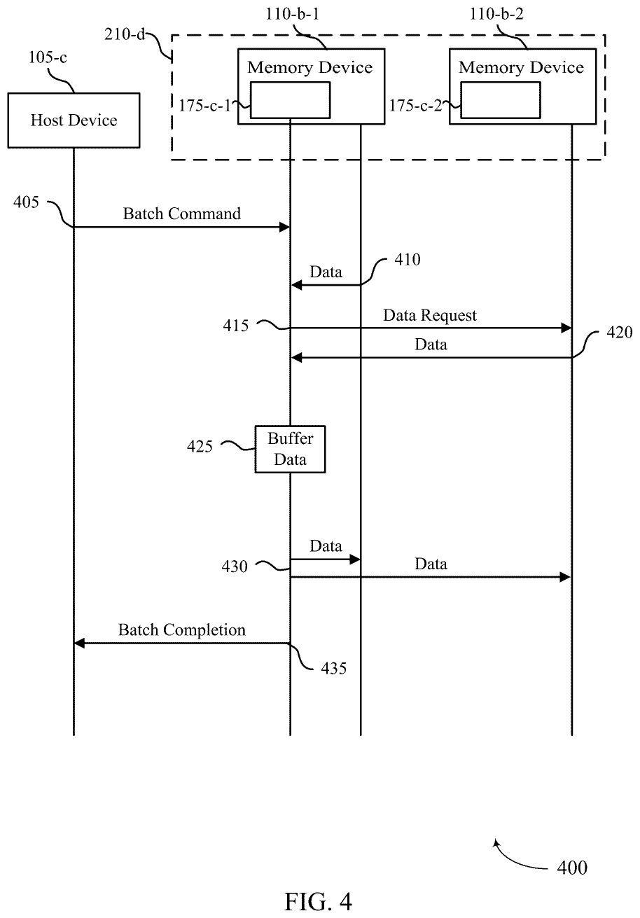

FIG. 4 shows an example of a process flow 400 that supports techniques for data transfer between tiered memory devices in accordance with examples as disclosed herein. The process flow 400 may be implemented by aspects of system 100, the system 200, the system 300, or a combination thereof. For example, aspects of the process flow 400 may be implemented by a host device 105-c and a memory system 210-d, which may include multiple memory devices, such as a memory device 110-b-1 and a memory device 110-b-2. The memory devices 110-b may each include a data transfer engine 175-c (e.g., data transfer engine 175-c-1 and data transfer engine 175-c-2). In some examples, the memory device 110-b-1 may be associated with a different tier than the memory device 110-b-2.

At 405, the data transfer engine 175-c-1 may receive a first command from the host device 105-c. The first command may indicate a set of source addresses and a set of destination addresses within the memory system 210-d. The first command may indicate to transfer multiple data sets from a respective source address of the set of source addresses to a respective destination address of the set of destination addresses. In some cases, at least one source address of the set of source addresses may be the same address as at least one destination address of the set of destination addresses.

In some example, the first command may be stored at the data transfer engine 175-c-1, at a location within the memory of memory device 110-b-1, or a combination thereof. In some cases, each data set may be associated with a respective source address which corresponds to a respective first memory tier and a respective destination address which corresponds to a respective second memory tier. In such a case, the first memory tier may have a first access rate (e.g., a first set of performance characteristics), and the second memory tier may have a second access rate (e.g., a second set of performance characteristics) different from the first access rate.

In some cases, the first command may be an example of a batch command. For example, the first command may include a set of fields (e.g., data set fields) which each include information associated with the transfer of the data sets. For example, each field of the set of fields may include an identifier associated with the first command (e.g., a batch identifier), a respective source address of the set of source addresses and a respective destination address of the set of destination addresses both corresponding to a respective data set, a size of the respective data set, an indication of an interrupt policy, or any combination thereof.

At 410, the data transfer engine 175-c-1 may read each data set from the respective source address of the set of source addresses provided by the host device 105-c in the first command. In some instances, reading a first data set may at least partially overlap in time (e.g., occur concurrently) with reading a second data set. In some cases, a source address indicated in the batch command may correspond to a separate memory device, such as the memory device 110-b-2. In such cases, at 415, the data transfer engine 175-c-1 issue a request (e.g., a read request) to the memory device 110-b-2 to read the source address, and the memory device 110-b-2 may, at 420, output the corresponding data set to the data transfer engine 175-c-1.

At 425, the data transfer engine 175-c-1 may write each data set to a buffer associated with the data transfer engine 175-c-1 after reading the data sets from the respective source addresses. At 430, the data transfer engine 175-c-1 may output each data set from the buffer to the respective destination address. In some examples, such as if a destination address is within the memory device 110-b-2, the data transfer engine 175-c-1 may write the corresponding data set to the destination address (e.g., as part of a peer-to-peer transfer operation).

In some cases, the data transfer engine 175-c may swap the locations in memory of the data sets (e.g., shuffle the data sets) associated with the first command. For example, the first command may indicate a first data set associated with a first source address and a first destination address, a second data set associated with a second source address and a second destination address, and a third data set associated with a third source address and a third destination address. The first destination address may correspond to the second source address, the second destination address may correspond to the third source address, and the third destination address may correspond to the first source address. Thus, upon transferring the first data set, second data set, and third data set, the data sets may swap locations in memory. Although described as swapping three data sets, one skilled in the art may appreciate that such techniques may be expanded to any quantity of data sets (e.g., as part of an N-way shuffle).

At 435, the data transfer engine 175-c-1 may transmit an indication to the host device 105-c that each data set of the plurality of data sets has been transferred. In some cases, the data transfer engine 175-c-1 may transmit an indication after completing the transfer indicated by each data set field of the first command, after completing all of the transfers indicated by the first command, or a combination thereof. To assist in transmitting the indication, the data transfer engine 175-c-1 may modify a value of a counter (e.g., the counter 335) by an amount associated with the data sets. In some cases, the amount may correspond to the size of the data sets, the quantity of data sets, or a combination thereof. The data transfer engine 175-c-1 may modify the value of the counter in response to transferring each data set. The indication may be an example of an indication sent by the migration controller 325.

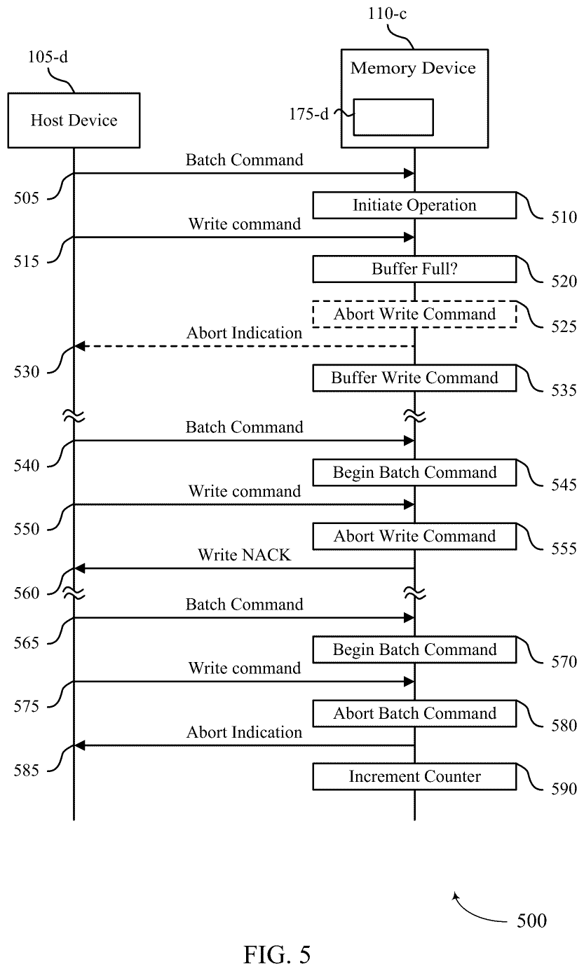

FIG. 5 shows an example of a process flow 500 that supports techniques for data transfer between tiered memory devices in accordance with examples as disclosed herein. The process flow 500 may be implemented by aspects of system 100, the system 200, the system 300, or a combination thereof. For example, aspects of the process flow 500 may be implemented by a host device 105-d and a memory system which includes a memory device 110-c. The memory devices 110-c may include a data transfer engine 175-d.

The process flow 500 may illustrate multiple examples of interrupt policies supported by the data transfer engine 175-d. For example, steps 505 through 535 may illustrate a first possible example of an interrupt policy. Additionally, steps 540 through 560 and 565 through 590 may illustrate a second and third possible example of an interrupt policy, respectively.

At 505, the memory device 110-c may receive a first command (e.g., a batch command) at the data transfer engine 175-d from the host device 105-d. The first command may indicate one or more source addresses, one or more destination addresses, an indication of a first interrupt policy, or a combination thereof. The first command may indicate to transfer each data set of one or more data sets from a respective source address of the one or more source addresses to a respective destination address of the one or more destination addresses, according to the first interrupt policy.

At 510, the data transfer engine 175-d may initiate a data transfer operation to transfer each data set of the one or more data sets from the respective source address to the respective destination address (e.g., in accordance with the process flow 400). At 515, the memory device 110-c may receive, from the host device 105-c and during at least a portion of the data transfer operation, a first write command. The data transfer engine 175-d may detect (e.g., snoop) the first write command, and may determine whether the first write command indicates an address corresponding to a source address or a destination address (or both) indicated in the batch command. If the first write command does not indicate such an address, the data transfer engine may continue performing the data transfer operation.

Alternatively, if the first write command does indicate such an address, the data transfer engine 175-d may implement the first interrupt policy. For example, at 520, the data transfer engine 175-d may determine whether a command buffer is full. If the command buffer is full (e.g., if a quantity of commands stored in the command buffer exceeds a command buffer threshold), the data transfer engine 175-d may, at 525, abort the first write command and, at 530, indicate to the host device 105-c that first write command has been aborted. In some cases, the data transfer engine 175-d may transmit the indication of the aborted first write command. Additionally, or alternatively, the data transfer engine 175-d may store the indication in a location accessible by the host device 105-d, and the host device 105-d may read the indication from the location.

If the command buffer is not full, the data transfer engine 175-b may, at 535, store the received first write command to the command buffer. After completing the data transfer operation (e.g., after transferring each data set of the one or more data sets from the respective source address to the respective destination address), the data transfer engine 175-d may instruct the memory device 110-c to write data associated with the received first write command to the write address indicated by the first write command.

At 540, 545, and 550, the data transfer engine 175-d may receive a second command from the host device 105-d indicating a second interrupt policy, initiate a second operation to transfer each data set of one or more data sets in response to the second command, and receive a second write command from the host device 105-d during at least a portion of the second data transfer operation. The data transfer engine 175-d may detect (e.g., snoop) the second write command, and may determine whether the second write command indicates an address corresponding to a source address or a destination address (or both) indicated in the second batch command. If the second write command does not indicate such an address, the data transfer engine may continue performing the data transfer operation.

Alternatively, if the second write command does indicate such an address, the data transfer engine 175-d may implement the second interrupt policy. For example, at 555, the data transfer engine 175-d may abort the second write command (e.g., the second interrupt policy may be an abort-on-first-write policy). At 560, the data transfer engine 175-d may transmit an indication to the host device 105-d that the second write command was aborted. In some cases, the indication may be a not-acknowledged (NACK) indication.

At 565, 570, and 575, the data transfer engine 175-d may receive a third batch command from the host device 105-d indicating a third interrupt policy, initiate a third operation to transfer each data set of one or more data sets in response to the third command, and receive a third write command from the host device 105-d during at least a portion of the third data transfer operation. The data transfer engine 175-d may detect (e.g., snoop) the third write command, and may determine whether the third write command indicates an address corresponding to a source address or a destination address (or both) indicated in the third batch command. If the third write command does not indicate such an address, the data transfer engine may continue performing the third data transfer operation.

Alternatively, if the third write command does indicate such an address, the data transfer engine 175-d may implement the third interrupt policy. For example, at 580, the data transfer engine 175-d may abort the third data transfer operation (e.g., the third interrupt policy may be an interrupt-on-write policy). At 585, the data transfer engine 175-d may transmit an indication to the host device 105-d that the third operation is aborted.

In some cases, as part of the third interrupt policy at 590, the data transfer engine 175-d may increment a value of a counter in response to aborting the third operation. In some cases, the counter may be an example of the counter 335. Additionally, the data transfer engine 175-d may store an indication of the one or more data sets associated with the third operation in response to determining that the value of the counter exceeds a threshold (e.g., a counter threshold). For example, the data transfer engine 175-d may store the indication of the one or more data sets in a problem list (e.g., a problem list 340).

FIG. 6 shows a block diagram 600 of a data transfer engine 620 that supports techniques for data transfer between tiered memory devices in accordance with examples as disclosed herein. The data transfer engine 620 may be an example of aspects of a data transfer engine as described with reference to FIGS. 1 through 5. The data transfer engine 620, or various components thereof, may be an example of means for performing various aspects of techniques for data transfer between tiered memory devices as described herein. For example, the data transfer engine 620 may include a command reception component 625, a data transfer component 630, a transmission component 635, a data buffer component 640, a data output component 645, a counter control component 650, a command buffer component 655, a data storage component 660, or any combination thereof. Each of these components may communicate, directly or indirectly, with one another (e.g., via one or more buses).

The command reception component 625 may be configured as or otherwise support a means for receiving, at a data transfer engine, a command indicating to transfer each data set of a plurality of data sets from a respective source address of a plurality of source addresses to a respective destination address of a plurality of destination addresses of a memory system comprising one or more memory devices. The data transfer component 630 may be configured as or otherwise support a means for transferring each data set of the plurality of data sets from the respective source address to the respective destination address based on receiving the command. The transmission component 635 may be configured as or otherwise support a means for transmitting an indication to a host device that each data set of the plurality of data sets has been transferred.

In some examples, to support transferring each data set of the plurality of data sets, the data buffer component 640 may be configured as or otherwise support a means for writing each data set of the plurality of data sets to a buffer of the data transfer engine based on reading each data set of the plurality of data sets from the respective source address. In some examples, to support transferring each data set of the plurality of data sets, the data output component 645 may be configured as or otherwise support a means for outputting each data set of the plurality of data sets from the buffer to the respective destination address.

In some examples, reading a first data set of the plurality of data sets at least partially overlaps in time with reading a second data set of the plurality of data sets.

In some examples, at least one source address of the plurality of source addresses is a same address as at least one destination address of the plurality of destination addresses.

In some examples, the plurality of data sets includes a first data set associated with a first source address and a first destination address, a second data set associated with a second source address and a second destination address, and a third data set associated with a third source address and a third destination address. In some examples, the first destination address corresponds to the second source address, the second destination address corresponds to the third source address, and the third destination address corresponds to the first source address.

In some examples, for each data set of the plurality of data sets, the respective source address corresponds to a respective first memory tier having a first access rate and the respective destination address corresponding to a respective second memory tier having a second access rate different from the first access rate.

In some examples, the counter control component 650 may be configured as or otherwise support a means for modifying a value of a counter by an amount corresponding to a size of the plurality of data sets based on transferring each data set of the plurality of data sets.

In some examples, the counter control component 650 may be configured as or otherwise support a means for modifying a value of a counter by an amount corresponding to a quantity of data sets of the plurality of data sets based on transferring each data set of the plurality of data sets.

In some examples, the command reception component 625 may be configured as or otherwise support a means for receiving, from a second host device and at the data transfer engine, a second command indicating a plurality of second source addresses and a plurality of second destination addresses of the memory system, the second command indicating to transfer each second data set of a plurality of second data sets from a respective second source address of the plurality of second source addresses to a respective second destination address of the plurality of second destination addresses. In some examples, the data transfer component 630 may be configured as or otherwise support a means for transferring each second data set of the plurality of second data sets from the respective second source address to the respective second destination address based on receiving the second command. In some examples, the transmission component 635 may be configured as or otherwise support a means for transmitting an indication to the second host device that each second data set of the plurality of second data sets has been transferred.

In some examples, the command reception component 625 may be configured as or otherwise support a means for receiving, from a memory device of the one or more memory devices and at the data transfer engine, a second command indicating a plurality of second source addresses and a plurality of second destination addresses of the memory system, the second command indicating to transfer each second data set of a plurality of second data sets from a respective second source address of the plurality of second source addresses to a respective second destination address of the plurality of second destination addresses. In some examples, the data transfer component 630 may be configured as or otherwise support a means for transferring each second data set of the plurality of second data sets from the respective second source address to the respective second destination address based on receiving the second command. In some examples, the transmission component 635 may be configured as or otherwise support a means for transmitting an indication to the host device that each second data set of the plurality of second data sets has been transferred.

In some examples, the command includes a plurality of fields, each field of the plurality of fields including an identifier associated with the command, a respective source address of the plurality of source addresses and a respective destination address of the plurality of destination addresses, the respective source address and the respective destination address corresponding to a respective data set of the plurality of data sets, a size of the respective data set, an indication of an interrupt policy of a plurality of interrupt policies, or any combination thereof.

In some examples, the memory system includes a memory device including the data transfer engine. In some examples, at least one of the plurality of source addresses corresponds to a location in the memory device and at least one of the plurality of destination addresses corresponds to a location in a separate memory device.

In some examples, the memory system includes a memory device including the data transfer engine. In some examples, at least one of the plurality of destination addresses corresponds to a location in the memory device and at least one of the plurality of source addresses corresponds to a location in a separate memory device.

In some examples, the command reception component 625 may be configured as or otherwise support a means for receiving, at a data transfer engine, a command to transfer each data set of one or more data sets from a respective source address of one or more source addresses to a respective destination address of one or more destination addresses of a memory system, the command comprising an indication of an interrupt policy of a plurality of interrupt policies. In some examples, the data transfer component 630 may be configured as or otherwise support a means for initiating an operation to transfer each data set of the one or more data sets from the respective source address to the respective destination address. In some examples, the command reception component 625 may be configured as or otherwise support a means for receiving, from a host device and during at least a portion of the operation, a write command including a write address, the write address corresponding to a source address of the one or more source addresses, a destination address of the one or more destination addresses, or both.

In some examples, the command buffer component 655 may be configured as or otherwise support a means for storing the write command to a command buffer based on the indication of the interrupt policy. In some examples, the data transfer component 630 may be configured as or otherwise support a means for transferring each data set of the one or more data sets from the respective source address to the respective destination address based on storing the write command. In some examples, the data storage component 660 may be configured as or otherwise support a means for writing data associated with the write command to the write address after transferring each data set of the one or more data sets.

In some examples, the command buffer component 655 may be configured as or otherwise support a means for storing the write command to a command buffer based on the indication of the interrupt policy. In some examples, the command reception component 625 may be configured as or otherwise support a means for receiving, from the host device, a second write command including a second write address, the second write address corresponding to a source address of the one or more source addresses, a destination address of the one or more destination addresses, or both. In some examples, the command buffer component 655 may be configured as or otherwise support a means for aborting the second write command based on determining that the command buffer is full.

In some examples, the transmission component 635 may be configured as or otherwise support a means for transmitting an indication that the second write command is aborted to the host device.

In some examples, the command reception component 625 may be configured as or otherwise support a means for aborting the write command based on the indication of the interrupt policy. In some examples, the transmission component 635 may be configured as or otherwise support a means for transmitting an indication that the write command is aborted to the host device.

In some examples, the data transfer component 630 may be configured as or otherwise support a means for aborting the operation to transfer each data set of the one or more data sets from the respective source address to the respective destination address based on the indication of the interrupt policy. In some examples, the transmission component 635 may be configured as or otherwise support a means for transmitting an indication the operation is aborted to the host device.

In some examples, the counter control component 650 may be configured as or otherwise support a means for incrementing a value of a counter based on aborting the operation.

In some examples, the counter control component 650 may be configured as or otherwise support a means for storing an indication of the one or more data sets based on determining that the value of the counter exceeds a threshold.

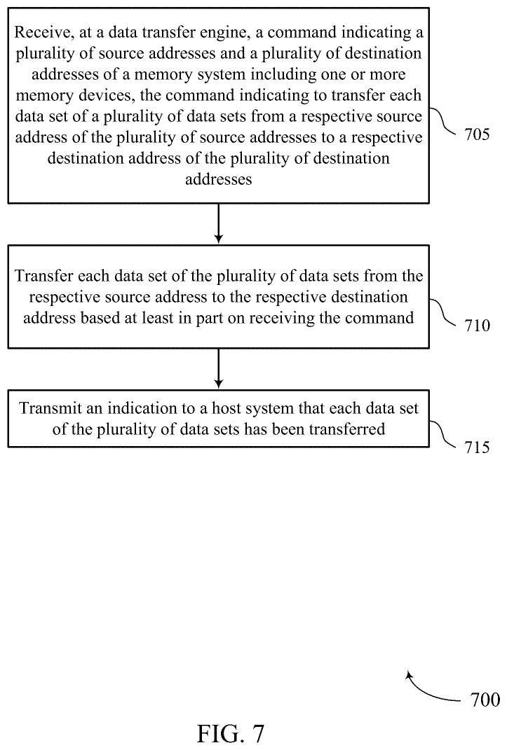

FIG. 7 shows a flowchart illustrating a method 700 that supports techniques for data transfer between tiered memory devices in accordance with examples as disclosed herein. The operations of method 700 may be implemented by a data transfer engine or its components as described herein. For example, the operations of method 700 may be performed by a data transfer engine as described with reference to FIGS. 1 through 6. In some examples, a data transfer engine may execute a set of instructions to control the functional elements of the device to perform the described functions. Additionally, or alternatively, the data transfer engine may perform aspects of the described functions using special-purpose hardware.

At 705, the method may include receiving, at a data transfer engine, a command indicating to transfer each data set of a plurality of data sets from a respective source address of a plurality of source addresses to a respective destination address of a plurality of destination addresses of a memory system comprising one or more memory devices. The operations of 705 may be performed in accordance with examples as disclosed herein. For example, the data transfer engine may include an interface 305, as described with reference to FIG. 3, which may receive the command.

At 710, the method may include transferring each data set of the plurality of data sets from the respective source address to the respective destination address based on receiving the command. The operations of 710 may be performed in accordance with examples as disclosed herein. For example, the data transfer engine may include a data mover 315, as described with reference to FIG. 3, which may transfer the data sets.

At 715, the method may include transmitting an indication to a host device that each data set of the plurality of data sets has been transferred. The operations of 715 may be performed in accordance with examples as disclosed herein. For example, the data transfer engine may include an interface 305, as described with reference to FIG. 3, which may transmit the indication.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at a data transfer engine, a command indicating to transfer each data set of a plurality of data sets from a respective source address of a plurality of source addresses to a respective destination address of a plurality of destination addresses of a memory system comprising one or more memory devices; transferring each data set of the plurality of data sets from the respective source address to the respective destination address based on receiving the command; and transmitting an indication to a host device that each data set of the plurality of data sets has been transferred.

Aspect 2: The method, apparatus, or non-transitory computer-readable medium of aspect 1, where transferring each data set of the plurality of data sets includes operations, features, circuitry, logic, means, or instructions, or any combination thereof for writing each data set of the plurality of data sets to a buffer of the data transfer engine based on reading each data set of the plurality of data sets from the respective source address and outputting each data set of the plurality of data sets from the buffer to the respective destination address.

Aspect 3: The method, apparatus, or non-transitory computer-readable medium of aspect 2, where reading a first data set of the plurality of data sets at least partially overlaps in time with reading a second data set of the plurality of data sets.

Aspect 4: The method, apparatus, or non-transitory computer-readable medium of any of aspects 1 through 3, where at least one source address of the plurality of source addresses is a same address as at least one destination address of the plurality of destination addresses.

Aspect 5: The method, apparatus, or non-transitory computer-readable medium of any of aspects 1 through 4, where the plurality of data sets includes a first data set associated with a first source address and a first destination address, a second data set associated with a second source address and a second destination address, and a third data set associated with a third source address and a third destination address and the first destination address corresponds to the second source address, the second destination address corresponds to the third source address, and the third destination address corresponds to the first source address.

Aspect 6: The method, apparatus, or non-transitory computer-readable medium of any of aspects 1 through 5, where for each data set of the plurality of data sets, the respective source address corresponds to a respective first memory tier having a first access rate and the respective destination address corresponding to a respective second memory tier having a second access rate different from the first access rate.

Aspect 7: The method, apparatus, or non-transitory computer-readable medium of any of aspects 1 through 6, further including operations, features, circuitry, logic, means, or instructions, or any combination thereof for modifying a value of a counter by an amount corresponding to a size of the plurality of data sets based on transferring each data set of the plurality of data sets.

Aspect 8: The method, apparatus, or non-transitory computer-readable medium of any of aspects 1 through 7, further including operations, features, circuitry, logic, means, or instructions, or any combination thereof for modifying a value of a counter by an amount corresponding to a quantity of data sets of the plurality of data sets based on transferring each data set of the plurality of data sets.

Aspect 9: The method, apparatus, or non-transitory computer-readable medium of any of aspects 1 through 8, further including operations, features, circuitry, logic, means, or instructions, or any combination thereof for receiving, from a second host device and at the data transfer engine, a second command indicating a plurality of second source addresses and a plurality of second destination addresses of the memory system, the second command indicating to transfer each second data set of a plurality of second data sets from a respective second source address of the plurality of second source addresses to a respective second destination address of the plurality of second destination addresses; transferring each second data set of the plurality of second data sets from the respective second source address to the respective second destination address based on receiving the second command; and transmitting an indication to the second host device that each second data set of the plurality of second data sets has been transferred.

Aspect 10: The method, apparatus, or non-transitory computer-readable medium of any of aspects 1 through 9, further including operations, features, circuitry, logic, means, or instructions, or any combination thereof for receiving, from a memory device of the one or more memory devices and at the data transfer engine, a second command indicating a plurality of second source addresses and a plurality of second destination addresses of the memory system, the second command indicating to transfer each second data set of a plurality of second data sets from a respective second source address of the plurality of second source addresses to a respective second destination address of the plurality of second destination addresses; transferring each second data set of the plurality of second data sets from the respective second source address to the respective second destination address based on receiving the second command; and transmitting an indication to the host device that each second data set of the plurality of second data sets has been transferred.

Aspect 11: The method, apparatus, or non-transitory computer-readable medium of any of aspects 1 through 10, where the command includes a plurality of fields, each field of the plurality of fields including an identifier associated with the command, a respective source address of the plurality of source addresses and a respective destination address of the plurality of destination addresses, the respective source address and the respective destination address corresponding to a respective data set of the plurality of data sets, a size of the respective data set, an indication of an interrupt policy of a plurality of interrupt policies, or any combination thereof.

Aspect 12: The method, apparatus, or non-transitory computer-readable medium of any of aspects 1 through 11, where the memory system includes a memory device including the data transfer engine and at least one of the plurality of source addresses corresponds to a location in the memory device and at least one of the plurality of destination addresses corresponds to a location in a separate memory device.

Aspect 13: The method, apparatus, or non-transitory computer-readable medium of any of aspects 1 through 12, where the memory system includes a memory device including the data transfer engine and at least one of the plurality of destination addresses corresponds to a location in the memory device and at least one of the plurality of source addresses corresponds to a location in a separate memory device.

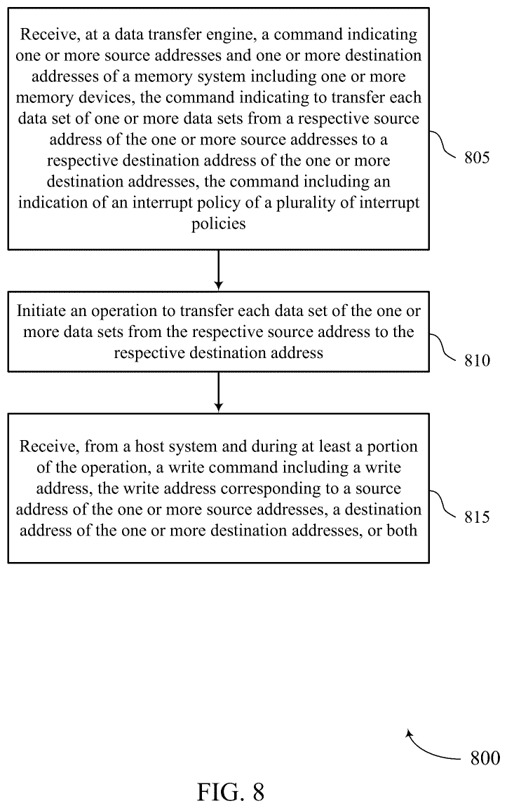

FIG. 8 shows a flowchart illustrating a method 800 that supports techniques for data transfer between tiered memory devices in accordance with examples as disclosed herein. The operations of method 800 may be implemented by a data transfer engine or its components as described herein. For example, the operations of method 800 may be performed by a data transfer engine as described with reference to FIGS. 1 through 6. In some examples, a data transfer engine may execute a set of instructions to control the functional elements of the device to perform the described functions. Additionally, or alternatively, the data transfer engine may perform aspects of the described functions using special-purpose hardware.

At 805, the method may include receiving, at a data transfer engine, a command to transfer each data set of one or more data sets from a respective source address of one or more source addresses to a respective destination address of one or more destination addresses of a memory system, the command comprising an indication of an interrupt policy of a plurality of interrupt policies. The operations of 805 may be performed in accordance with examples as disclosed herein. For example, the data transfer engine may include an interface 305, as described with reference to FIG. 3, which may receive the command.

At 810, the method may include initiating an operation to transfer each data set of the one or more data sets from the respective source address to the respective destination address. The operations of 810 may be performed in accordance with examples as disclosed herein. For example, the data transfer engine may include a data mover 315, as described with reference to FIG. 3, which may initiate the operation to transfer the data sets.

At 815, the method may include receiving, from a host device and during at least a portion of the operation, a write command including a write address, the write address corresponding to a source address of the one or more source addresses, a destination address of the one or more destination addresses, or both. The operations of 815 may be performed in accordance with examples as disclosed herein. For example, the data transfer engine may include an interface 305, as described with reference to FIG. 3, which may receive the write command.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 14: A method, apparatus, or non-transitory computer-readable medium including operations, features, circuitry, logic, means, or instructions, or any combination thereof for receiving, at a data transfer engine, a command to transfer each data set of one or more data sets from a respective source address of one or more source addresses to a respective destination address of one or more destination addresses of a memory system, the command comprising an indication of an interrupt policy of a plurality of interrupt policies; initiating an operation to transfer each data set of the one or more data sets from the respective source address to the respective destination address; and receiving, from a host device and during at least a portion of the operation, a write command including a write address, the write address corresponding to a source address of the one or more source addresses, a destination address of the one or more destination addresses, or both.

Aspect 15: The method, apparatus, or non-transitory computer-readable medium of aspect 14, further including operations, features, circuitry, logic, means, or instructions, or any combination thereof for storing the write command to a command buffer based on the indication of the interrupt policy; transferring each data set of the one or more data sets from the respective source address to the respective destination address based on storing the write command; and writing data associated with the write command to the write address after transferring each data set of the one or more data sets.

Aspect 16: The method, apparatus, or non-transitory computer-readable medium of any of aspects 14 through 15, further including operations, features, circuitry, logic, means, or instructions, or any combination thereof for storing the write command to a command buffer based on the indication of the interrupt policy; receiving, from the host device, a second write command including a second write address, the second write address corresponding to a source address of the one or more source addresses, a destination address of the one or more destination addresses, or both; and aborting the second write command based on determining that the command buffer is full.

Aspect 17: The method, apparatus, or non-transitory computer-readable medium of aspect 16, further including operations, features, circuitry, logic, means, or instructions, or any combination thereof for transmitting an indication that the second write command is aborted to the host device.

Aspect 18: The method, apparatus, or non-transitory computer-readable medium of any of aspects 14 through 17, further including operations, features, circuitry, logic, means, or instructions, or any combination thereof for aborting the write command based on the indication of the interrupt policy and transmitting an indication that the write command is aborted to the host device.

Aspect 19: The method, apparatus, or non-transitory computer-readable medium of any of aspects 14 through 18, further including operations, features, circuitry, logic, means, or instructions, or any combination thereof for aborting the operation to transfer each data set of the one or more data sets from the respective source address to the respective destination address based on the indication of the interrupt policy and transmitting an indication the operation is aborted to the host device.

Aspect 20: The method, apparatus, or non-transitory computer-readable medium of aspect 19, further including operations, features, circuitry, logic, means, or instructions, or any combination thereof for incrementing a value of a counter based on aborting the operation.

Aspect 21: The method, apparatus, or non-transitory computer-readable medium of aspect 20, further including operations, features, circuitry, logic, means, or instructions, or any combination thereof for storing an indication of the one or more data sets based on determining that the value of the counter exceeds a threshold.

It should be noted that the methods described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The term “isolated” refers to a relationship between components in which signals are not presently capable of flowing between the components. Components are isolated from each other if there is an open circuit between them. For example, two components separated by a switch that is positioned between the components are isolated from each other when the switch is open. When a controller isolates two components, the controller affects a change that prevents signals from flowing between the components using a conductive path that previously permitted signals to flow.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component (e.g., a transistor) discussed herein may represent a field-effect transistor (FET), and may comprise a three-terminal component including a source (e.g., a source terminal), a drain (e.g., a drain terminal), and a gate (e.g., a gate terminal). The terminals may be connected to other electronic components through conductive materials (e.g., metals, alloys). The source and drain may be conductive, and may comprise a doped (e.g., heavily-doped, degenerate) semiconductor region. The source and drain may be separated by a doped (e.g., lightly-doped) semiconductor region or channel. If the channel is n-type (e.g., majority carriers are electrons), then the FET may be referred to as a n-type FET. If the channel is p-type (e.g., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” when a voltage greater than or equal to the transistor's threshold voltage is applied to the transistor gate. The transistor may be “off” or “deactivated” when a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over as one or more instructions (e.g., code) on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and modules described in connection with the disclosure herein may be implemented or performed with a processor, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or any type of processor. A processor may also be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a computer, or a processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The article “a” as used in the claims shall be understood to refer to one or more than one of the specified components. Thus, the terms “a,” “at least one,” and “one or more” are to be construed to be interchangeable. Subsequent reference to a component introduced with the article “a” using the terms “the” or “said” shall be construed as referring to any or all of the one or more components. That is, a component introduced with the article “a” shall be understood to mean “one or more components,” and referring to “the component” subsequently in the claims shall be understood to be equivalent to referring to “the one or more components.”

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
receiving, at a data transfer engine, a command indicating to transfer each data set of a plurality of data sets from a respective source address of a plurality of source addresses to a respective destination address of a plurality of destination addresses of a memory system from a respective source address of the plurality of source addresses to a respective destination address of the plurality of destination addresses;
transferring each data set of the plurality of data sets from the respective source address to the respective destination address based on receiving the command; and
transmitting an indication to a host device that each data set of the plurality of data sets has been transferred.

2. The method of claim 1, wherein transferring each data set of the plurality of data sets comprises:
writing each data set of the plurality of data sets to a buffer of the data transfer engine based on reading each data set of the plurality of data sets from the respective source address; and
outputting each data set of the plurality of data sets from the buffer to the respective destination address.

3. The method of claim 2, wherein reading a first data set of the plurality of data sets at least partially overlaps in time with reading a second data set of the plurality of data sets.

4. The method of claim 1, wherein at least one source address of the plurality of source addresses is a same address as at least one destination address of the plurality of destination addresses.

5. The method of claim 1, wherein:
the plurality of data sets comprises a first data set associated with a first source address and a first destination address, a second data set associated with a second source address and a second destination address, and a third data set associated with a third source address and a third destination address; and
the first destination address corresponds to the second source address, the second destination address corresponds to the third source address, and the third destination address corresponds to the first source address.

6. The method of claim 1, wherein for each data set of the plurality of data sets, the respective source address corresponds to a respective first memory tier having a first access rate and the respective destination address corresponding to a respective second memory tier having a second access rate different from the first access rate.

7. The method of claim 1, further comprising:
modifying a value of a counter by an amount corresponding to a size of the plurality of data sets based on transferring each data set of the plurality of data sets.

8. The method of claim 1, further comprising:
modifying a value of a counter by an amount corresponding to a quantity of data sets of the plurality of data sets based on transferring each data set of the plurality of data sets.

9. The method of claim 1, further comprising:
receiving, from a second host device and at the data transfer engine, a second command indicating a plurality of second source addresses and a plurality of second destination addresses of the memory system, the second command indicating to transfer each second data set of a plurality of second data sets from a respective second source address of the plurality of second source addresses to a respective second destination address of the plurality of second destination addresses;
transferring each second data set of the plurality of second data sets from the respective second source address to the respective second destination address based on receiving the second command; and
transmitting an indication to the second host device that each second data set of the plurality of second data sets has been transferred.

10. The method of claim 1, further comprising:
receiving, from a memory device of one or more memory devices and at the data transfer engine, a second command indicating a plurality of second source addresses and a plurality of second destination addresses of the memory system, the second command indicating to transfer each second data set of a plurality of second data sets from a respective second source address of the plurality of second source addresses to a respective second destination address of the plurality of second destination addresses;
transferring each second data set of the plurality of second data sets from the respective second source address to the respective second destination address based on receiving the second command; and
transmitting an indication to the host device that each second data set of the plurality of second data sets has been transferred.

11. The method of claim 1, wherein the command comprises a plurality of fields, each field of the plurality of fields comprising an identifier associated with the command, a respective source address of the plurality of source addresses and a respective destination address of the plurality of destination addresses, the respective source address and the respective destination address corresponding to a respective data set of the plurality of data sets, a size of the respective data set, an indication of an interrupt policy of a plurality of interrupt policies, or any combination thereof.

12. The method of claim 1, wherein:
the memory system comprises a memory device comprising the data transfer engine; and
at least one of the plurality of source addresses corresponds to a location in the memory device and at least one of the plurality of destination addresses corresponds to a location in a separate memory device.

13. The method of claim 1, wherein:
the memory system comprises a memory device comprising the data transfer engine; and
at least one of the plurality of destination addresses corresponds to a location in the memory device and at least one of the plurality of source addresses corresponds to a location in a separate memory device.

14. A method, comprising:
receiving, at a data transfer engine, a command to transfer each data set of one or more data sets from a respective source address of one or more source addresses to a respective destination address of one or more destination addresses of a memory system, the command comprising an indication of an interrupt policy of a plurality of interrupt policies;
initiating an operation to transfer each data set of the one or more data sets from the respective source address to the respective destination address; and
receiving, from a host device and during at least a portion of the operation, a write command comprising a write address, the write address corresponding to a source address of the one or more source addresses, a destination address of the one or more destination addresses, or both.

15. The method of claim 14, further comprising:
storing the write command to a command buffer based on the indication of the interrupt policy;
transferring each data set of the one or more data sets from the respective source address to the respective destination address based on storing the write command; and
writing data associated with the write command to the write address after transferring each data set of the one or more data sets.

16. The method of claim 14, further comprising:
storing the write command to a command buffer based on the indication of the interrupt policy;
receiving, from the host device, a second write command comprising a second write address, the second write address corresponding to a source address of the one or more source addresses, a destination address of the one or more destination addresses, or both; and
aborting the second write command based on determining that the command buffer is full.

17. The method of claim 16, further comprising:
transmitting an indication that the second write command is aborted to the host device.

18. The method of claim 14, further comprising:
aborting the write command based on the indication of the interrupt policy; and
transmitting an indication that the write command is aborted to the host device.

19. The method of claim 14, further comprising:
aborting the operation to transfer each data set of the one or more data sets from the respective source address to the respective destination address based on the indication of the interrupt policy; and
transmitting an indication the operation is aborted to the host device.

20. An apparatus, comprising: a controller associated with one or more memory devices, wherein the controller is configured to cause the apparatus to:
receive, at a data transfer engine, a command indicating to transfer each data set of a plurality of data sets from a respective source address of a plurality of source addresses to a respective destination address of a plurality of destination addresses of a memory system from a respective source address of the plurality of source addresses to a respective destination address of the plurality of destination addresses;
transfer each data set of the plurality of data sets from the respective source address to the respective destination address based on receiving the command; and
transmit an indication to a host device that each data set of the plurality of data sets has been transferred.
